(19) United States
(12) Patent Application Publication
(10) Pub. No.: US 2018/0093502 A1
(43) Pub. Date: Apr. 5, 2018

(54) CONVEYING APPARATUS AND RECORDING APPARATUS

(71) Applicant: CANON COMPONENTS, INC., Kodama-gun (JP)

(72) Inventors: Masashi ISHIMARU, Saitama (JP); Kenichi MATSUMOTO, Saitama (JP); Yoshihisa NEGISHI, Saitama (JP); Yoshihiro HATTORI, Saitama (JP)

(21) Appl. No.: 15/719,169

(22) Filed: Sep. 28, 2017

(30) Foreign Application Priority Data
Oct. 4, 2016 (JP) 2016-196736

(51) Int. Cl. B41J 11/00; B41J 2/01; B41J 13/26

(52) U.S. Cl. CPC B41J 11/0095; B41J 13/26; B41J 2/01

(57) ABSTRACT

Provided is a conveying apparatus including a conveying unit that conveys a recording paper along a conveyance path, an imaging unit that images the recording paper to detect conveyance information on the recording paper, and a light source unit that emits light to the recording paper imaged by the imaging unit, wherein the light source unit has a shape of a rod elongated in a conveyance direction of the recording paper.

### CROSS-REFERENCE TO RELATED APPLICATIONS

This application is based upon and claims the benefit of priority of the prior Japanese Patent Application No. 2016-196736, filed on Oct. 4, 2016, the entire contents of which are incorporated herein by reference.

### BACKGROUND OF THE INVENTION

### Field of the Invention

The present invention relates to a conveying apparatus and a recording apparatus.

### Description of the Related Art

There is a known recording apparatus that conveys a recording medium while controlling an amount of conveyance and that records an image on the recording medium. With a printing apparatus disclosed in Patent Document 1, an image obtained by an imaging unit is output to a controlling unit, and the control unit calculates an actual amount of conveyance of continuous paper based on the image and performs a conveyance control to control conveyance of the continuous paper based on a target amount of conveyance and the actual amount of conveyance. In the printing apparatus disclosed in Patent Document 1, the imaging unit includes a case, in which a light emitting unit formed by a light emitting diode (LED) is provided. The light emitting unit obliquely emits light to the continuous paper.

However, the printing apparatus disclosed in Patent Document 1 has a problem that, since the light emitting unit is formed by a single light emitting diode, the obtained image of the continuous paper varies in gray scale between parts close to the light emitting unit and parts away from the light emitting unit. In particular, the gray scale varies in the direction of conveyance of the continuous paper, so that, even at the same point on the continuous paper, the brightness of the image of the continuous paper being conveyed varies between first image data and second image data obtained at different timings, due to the variation in gray scale. This can lead to reduction in accuracy of calculation of the amount of conveyance of the continuous paper.

### Patent Document 1

### Japanese Laid-Open Patent Publication No. 2015-182309

### SUMMARY OF THE INVENTION

The present invention has been made in view of the problems, and an object of the present invention is to enable detecting highly accurate conveyance information.

The present invention provides a conveying apparatus including: a conveying unit that conveys a conveyed object along a conveyance path; an imaging unit that images the conveyed object to detect conveyance information on the conveyed object; and a light source unit that emits light to the conveyed object imaged by the imaging unit, wherein the light source unit has a shape of a rod elongated in a conveyance direction of the conveyed object.

The present invention also provides a recording apparatus including: a conveying unit that conveys a conveyed object along a conveyance path; an imaging unit that images the conveyed object to detect conveyance information on the conveyed object; a light source unit that emits light to the conveyed object imaged by the imaging unit; and a recording unit that records an image on the conveyed object conveyed by the conveying unit, wherein the light source unit has a shape of a rod elongated in a conveyance direction of the conveyed object.

### BRIEF DESCRIPTION OF THE DRAWINGS

FIG. 1 is a view illustrating a schematic configuration of a recording apparatus 100;

FIG. 2 is a perspective view illustrating a configuration of a light source unit 40 according to a first embodiment;

FIG. 3 is a block diagram illustrating an internal configuration of the recording apparatus 100;

FIG. 4A is a view illustrating how the light source unit 40 emits light;

FIG. 4B is a view illustrating how the light source unit 40 emits light;

FIG. 5 is a flow chart illustrating a process by a control unit 50;

FIG. 6 is a flow chart illustrating a process by the control unit 50;

FIG. 7 is a view illustrating an example of first image data 70 imaged by the imaging unit 30;

FIG. 8 is a view illustrating an example of second image data 80 imaged by the imaging unit 30;

FIG. 9 is a view illustrating a configuration of a light source unit 90 according to a second embodiment;

FIG. 10 is a view illustrating a configuration of a light source unit 110 according to a third embodiment; and

FIG. 11 is a view illustrating a configuration of a light source unit 120 according to a fourth embodiment.

### DETAILED DESCRIPTION OF THE PREFERRED EMBODIMENTS

An embodiment of the present invention will now be described in detail with reference to the drawings.

The present embodiment provides a conveying apparatus and a recording apparatus. The conveying apparatus conveys the conveyed object based on the conveyance information of the conveyed object. The recording apparatus forms an image on an object being conveyed by the conveying apparatus, or more specifically recording paper, and records the image.

In the following drawings, a conveyance direction F of the conveyed object will be expressed as an X direction, a direction orthogonal to the X direction and parallel to a conveyed surface will be expressed as a Y direction, and a direction orthogonal to the conveyed surface will be expressed as a Z direction, as necessary. The side of a paper feeding opening 14 described later in the conveyance direction F will be called an upstream, and the side of a paper discharge opening 15 described later will be called a downstream.

### First Embodiment

A recording apparatus 100 according to the present embodiment is applied to an inkjet type printer in the following description.

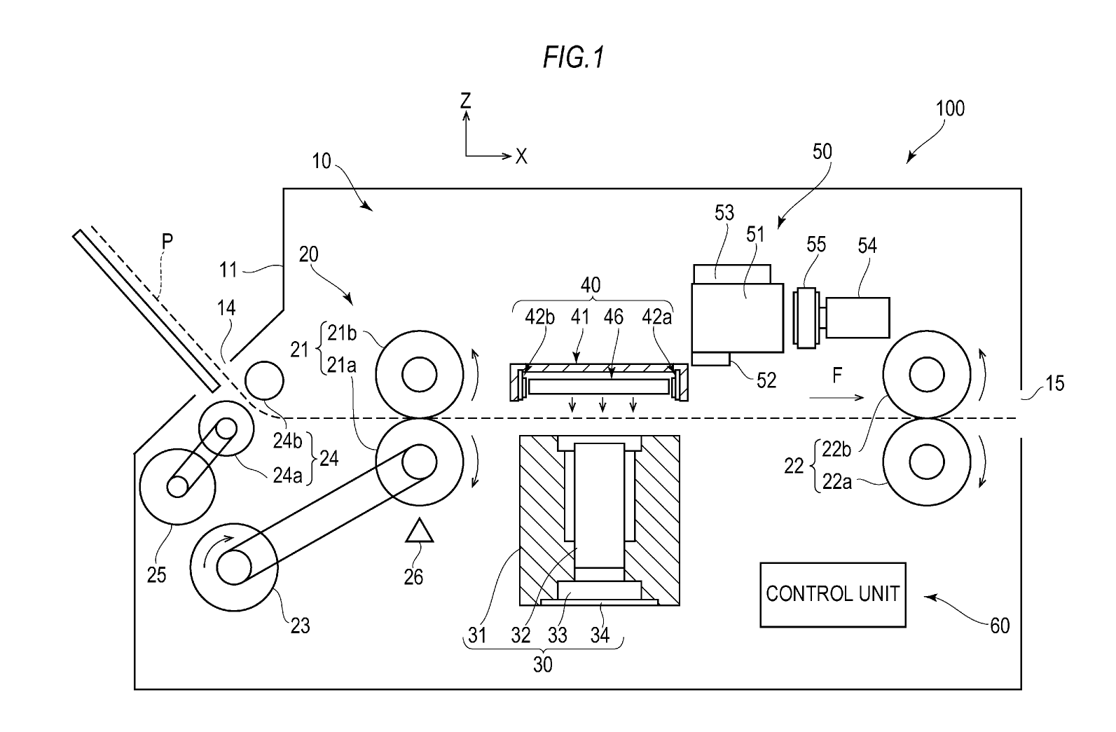

FIG. 1 is a view illustrating a schematic configuration of the recording apparatus 100.

The recording apparatus 100 includes a conveying apparatus 10, a recording unit 50, and a control unit 60 that controls operation of the conveying apparatus 10 and the recording unit 50.

The conveying apparatus 10 conveys a recording medium (hereinafter, called recording paper P) as a fed conveyed object along a conveyance path and discharges the recording medium after the recording medium passes through the recording unit 50. The conveying apparatus 10 includes a housing 11, a conveying unit 20, an imaging unit 30, and a light source unit 40.

The housing 11 houses and supports constituent members of the recording apparatus 100. The housing also includes the paper feeding opening 14 for feeding the recording paper P and the paper discharge opening 15 for discharging the recording paper P.

The conveying unit 20 conveys the recording paper P. The conveying unit 20 includes a first conveyor roller unit 21 and a second conveyor roller unit 22 as rotating bodies, a conveyor motor 23, a paper feeding roller unit 24, a paper feeding motor 25, and an encoder 26.

The first conveyor roller unit 21 includes a pair of rollers 21a and 21b and conveys the recording paper P placed between the rollers 21a and 21b. Similarly, the second conveyor roller unit 22 includes a pair of rollers 22a and 22b and conveys the recording paper P placed between the rollers 22a and 22b. The first conveyor roller unit 21 and the second conveyor roller unit 22 are rotatably supported by the housing 11 at positions separated in the conveyance direction. Therefore, a conveyance path of the recording paper P is formed between the pair of rollers 21a and 21b and between the pair of rollers 22a and 22b (the recording paper P and the conveyance path overlap in FIG. 1). The conveyor motor 23 rotates the first conveyor roller unit 21 and the second conveyor roller unit 22. Therefore, the drive of the conveyor motor 23 conveys the recording paper P placed between the pair of rollers 21a and 21b and the pair of rollers 22a and 22b in the conveyance direction (arrow F illustrated in FIG. 1). The paper feeding roller unit 24 includes a pair of rollers 24a and 24b and places the recording paper P between the rollers 24a and 24b. The paper feeding roller unit 24 separates each of a plurality of pieces of recording paper P loaded on a tray and feeds the recording paper P from the paper feeding opening 14. The paper feeding motor 25 rotates the paper feeding roller unit 24. Therefore, the paper feeding motor 25 rotates to feed the recording paper P placed between the pair of rollers 24a and 24b from the paper feeding opening 14. The encoder 26 detects a rotation state by reading a slit along a circumference of a code wheel not illustrated of the first conveyor roller unit 21 and transmits the detected information to the control unit 60.

The conveying unit 20 may be configured to bring the recording paper P into close contact with a conveyor belt to convey the recording paper P instead of conveying the recording paper P by the pairs of rollers.

The imaging unit 30 two-dimensionally images the surface of the recording paper P being conveyed by the conveying unit 20. More specifically, the imaging unit 30 is supported by the housing 11 such that a direction orthogonal to the surface of the recording paper P is an imaging direction. According to this embodiment, the imaging unit 30 is arranged on a lower side (one side) of the conveyance path of the recording paper P and therefor images the lower surface (surface on the one side) of the recording paper P. In addition, the imaging unit 30 is arranged upstream of the recording unit 50 in the conveyance direction F and therefore images the recording paper P before the image is recorded on the recording paper P by the recording unit 50. The imaging unit 30 transmits the taken image information to the control unit 60.

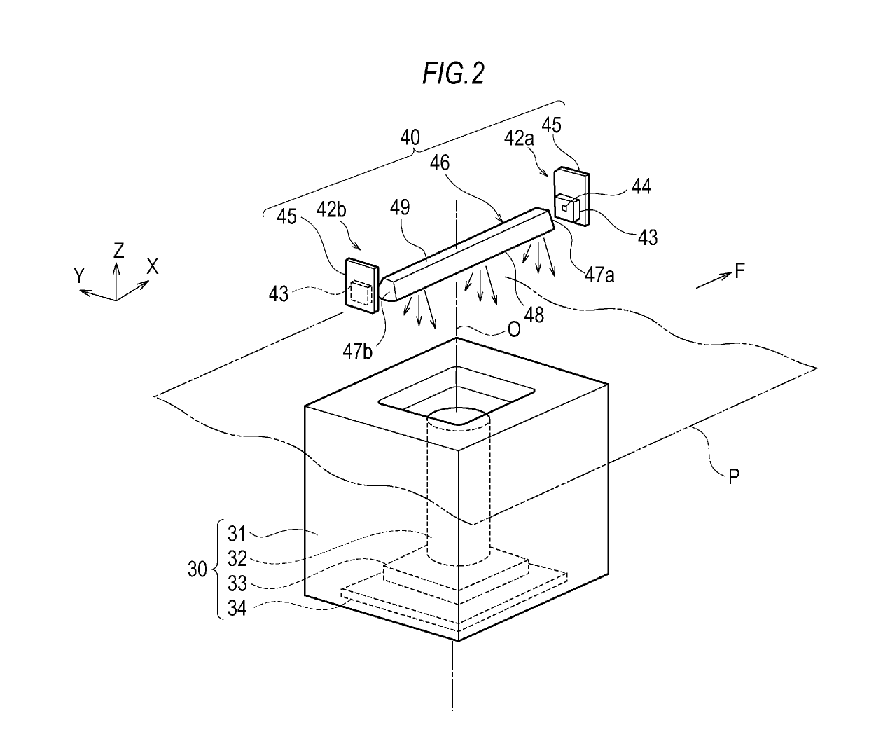

FIG. 2 is a perspective view illustrating the imaging unit 30 and the light source unit 40.

The imaging unit 30 has a supporting member 31, a lens 32, an image sensor 33 and a sensor substrate 34. The supporting member 31 has a rectangular solid shape and supports the positioned constituent members of the imaging unit 30. The lens 32 focuses light emitted by the light source unit 40 and transmitted through the recording paper P onto an imaging surface of the image sensor 33. The image sensor 33 receives the light focused by the lens 32 and converts the light into image information. The image sensor 33 has two-dimensional imaging surface that is parallel to the X direction and the Y direction. The image sensor 33 is mounted on the sensor substrate 34, and the sensor substrate 34 is connected to the control unit 60 through a flexible cable or the like.

The imaging range of the imaging unit 30 can include, for example, 1024 pixels×1024 pixels. Assuming that a pitch of one pixel is, for example, 10 μm here, the imaging range is 10.24 mm×10.24 mm. The imaging range can be set to a size according to an amount of conveyance.

The light source unit 40 has the shape of a rod elongated in the conveyance direction of the recording paper P and emits light to the recording paper P. More specifically, the light source unit 40 emits light along the conveyance direction F to the recording paper P imaged by the imaging unit 30. In this embodiment, the light source unit 40 is supported by the housing 11 on the opposite side of the imaging unit 30 across the conveyance path. The light source unit 40 has a frame 41 (see FIG. 1), a first light source 42a, a second light source 42b, light source substrates 45, and a light guide 46.

FIG. 2 shows the light source unit 40 without the frame 41.

The first light source 42a and the second light source 42b emit light to the recording paper P through the light guide 46. The first light source 42a can be an LED device 43 formed by an LED chip 44 sealed by a transparent resin. The LED device 43 is of a surface-mount type and emits white light, for example. The second light source 42b can be configured in the same manner as the first light source 42a. The first light source 42a and the second light source 42b are positioned at the opposite ends of the light guide 46 in the longitudinal direction.

A pair of light source substrates 45 is provided. The first light source 42a and the second light source 42b are mounted on the respective ones of the light source substrates 45, and the light source substrates 45 are connected to the control unit 60 through a flexible cable or the like.

The light guide 46 guides the light emitted by the first light source 42a and the second light source 42b toward to the recording paper P. The light guide 46 has a rod shape and is arranged in such a manner that the longitudinal direction thereof agrees with the conveyance direction F. In addition, the light guide 46 is arranged in such a manner that the light guide 46 intersects with an optical axis O of the lens 32 and the longitudinal direction thereof is perpendicular to the optical axis O of the lens 32. The length of the light guide 46 in the longitudinal direction is preferably substantially equal to the dimension of the imaging range imaged by the imaging unit 30 in the conveyance direction or greater than the dimension in the conveyance direction. The light guide 46 is made of a transparent resin material, such as an acrylic resin or polycarbonate.

An end face of the light guide 46 on one side in the longitudinal direction forms a first incident surface 47a on which light from the first light source 42a is incident, and an end face of the light guide 46 on the other side in the longitudinal direction forms a second incident surface 47b on which light from the second light source 42b is incident. A surface of the light guide 46 facing the upper surface (surface on the other side) of the recording paper P forms a continuous curved emission surface 48 from which the light launched into the light guide 46 is emitted toward the recording paper P. A surface of the light guide 46 opposite to the emission surface 48 forms a planar diffusing surface on which the light incident on the incident surfaces 47a and 47b is reflected and diffused. On the diffusing surface 49, a light diffusing pattern is formed of a light reflective paint by silk screen printing, for example. The light incident on the first incident surface 47a and the second incident surface 47b is diffused by the light diffusing pattern on the diffusing surface 49, so that linear light is emitted from the emission surface 48 toward the recording paper P. The light diffusing pattern is shaped to make the amount of light emitted from the emission surface 48 uniform in the longitudinal direction. Because of the light emitted from the light guide 46, the illuminance on the recording paper P is highest at the position directly below the light guide 46.

The light source unit 40 emits light toward the recording paper P, and therefore the imaging unit 30 images the recording paper P through which the light is transmitted.

The recording unit 50 records an image or the like on the upper surface of the conveyed recording paper P. The recording unit 50 is arranged on the downstream of the imaging unit 30 in the conveyance direction F and is configured to record the image on the recording paper P after the image is taken by the imaging unit 30. The recording unit 50 includes a carriage 51, a recording head 52, an ink tank 53, and a carriage moving motor 54. The carriage 51 is driven by the carriage moving motor 54 to move back and forth in the direction orthogonal to the conveyance direction F of the recording paper P and parallel to the surface of the recording paper P, that is, in the Y direction. The recording head 52 discharges ink from a nozzle toward the upper surface of the recording paper P in conjunction with the backward and forward movement of the carriage 51. The ink tank 53 supplies stored ink to the recording head 52. The carriage moving motor 54 moves the carriage 51 back and forth through a belt 55.

The recording unit 50 is not limited to the inkjet type, and an electrophotographic type, a thermal transfer type, a dot impact type or the like may also be adopted.

The control unit 60 controls the conveying apparatus 10 and the recording unit 50. Specifically, the control unit 60 alternately repeats instructing the conveying apparatus 10 to convey the recording paper P with an amount of conveyance for one step and instructing the recording unit 50 to discharge the ink from the nozzle of the recording head 52 to record an image for one step. Therefore, a process by the conveying apparatus 10 conveying the recording paper P for one step and a process by the recording unit 50 recording an image for one step are repeated in the recording apparatus 100 to record a desired image on the entire surface of the recording paper P.

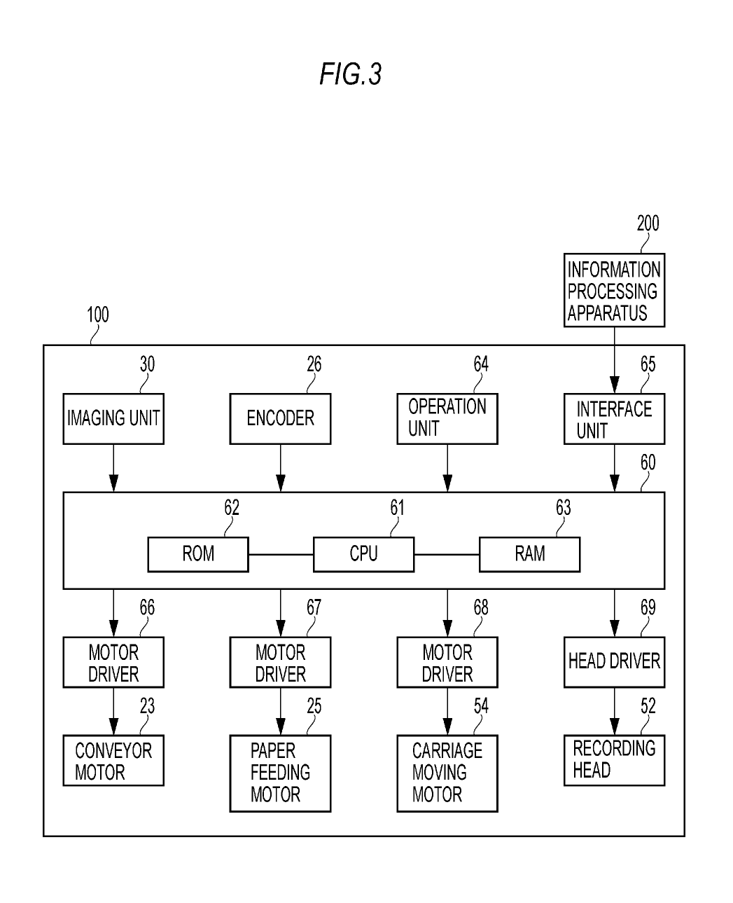

FIG. 3 is a block diagram illustrating an internal configuration of the recording apparatus 100 with a focus on the control unit 60.

The control unit 60 includes a CPU 61, a ROM 62, and a RAM 63 and functions as a so-called computer.

The CPU 61 expands a program stored in the ROM 62 to the RAM 63 and executes the program to control the entire recording apparatus 100. The program and data necessary for a process by the CPU 61 are stored in the ROM 62. The RAM 63 is a memory that temporarily stores information when the CPU 61 executes the process.

The control unit 60 is connected to the imaging unit 30, the encoder 26, an operation unit 64, and an information processing apparatus 200 and is configured to receive information from them. A user operates the operation unit 64 to issue an instruction to the control unit 60. Examples of the operation unit 64 include a switch, a button, and a touch panel. Examples of the information processing apparatus 200 include a PC, a smartphone, and a tablet terminal, and the information processing apparatus 200 is connected in a wireless or wired manner through an interface unit 65.

The control unit 60 is connected to the conveyor motor 23, the paper feeding motor 25, the carriage moving motor 54, and the recording head 52 through motor drivers 66, 67, and 68 and a head driver 69, respectively, and is configured to transmit information to them.

In the recording apparatus 100 configured as described above, the imaging unit 30 images, at different timings, the recording paper P being conveyed and transmits the taken image information to the control unit 60. Based on two pieces of image information taken at different timings, the control unit 60 uses pattern matching to detect actual conveyance information of the recording paper P, specifically, a distance conveyed in the X direction and a distance conveyed in the Y direction (specifically, distance displaced in the Y direction). Therefore, the control unit 60 functions as a conveyance detection apparatus that detects conveyance information. The control unit 60 also controls the recording head 52 to discharge the ink according to the detected actual conveyance information. Therefore, the recording unit 50 can record an image without a break and without an overlap.

As described above, the conveying apparatus 10 of the present embodiment is configured so that the light source unit 40 emits light to the recording paper P imaged by the imaging unit 30 along the conveyance direction F of the recording paper P. Therefore, on the recording paper P irradiated with the light from the light source unit 40, the gray scale varies in the direction (direction Y) perpendicular to the conveyance direction F because the distance from the light source unit 40 varies in the direction perpendicular to the conveyance direction F. On the other hand, the distance from the light source unit 40 is constant along the conveyance direction F, and therefore the gray scale does not vary along the conveyance direction F.

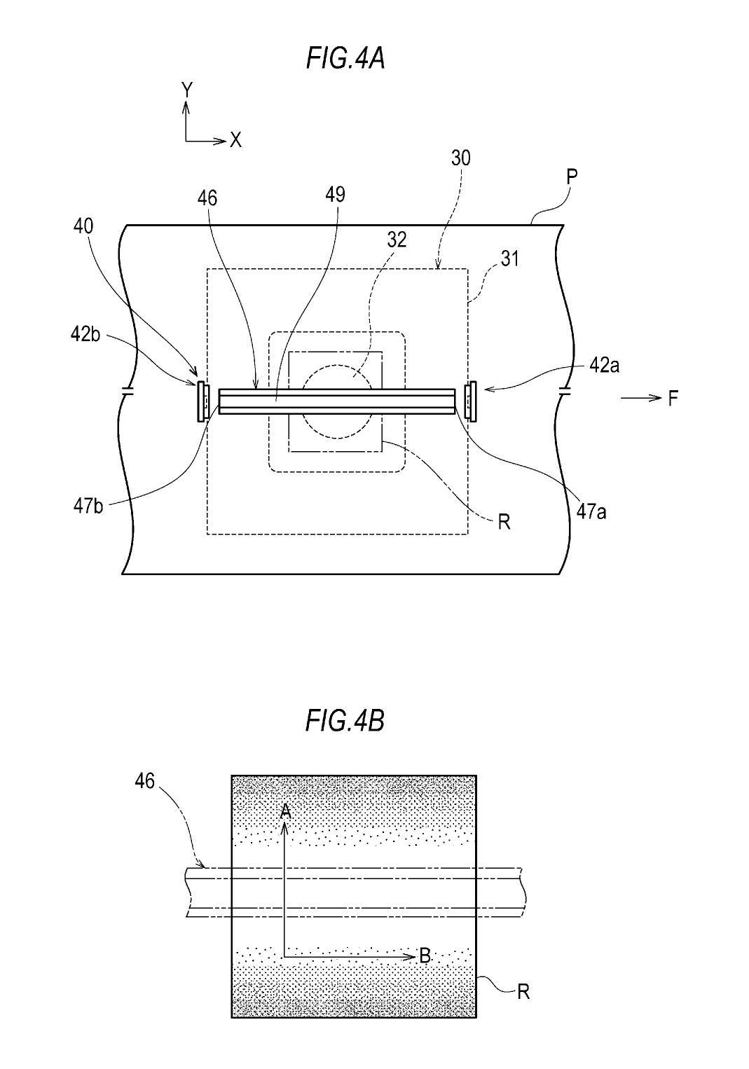

With reference to FIG. 4A and FIG. 4B, the gray scale on the recording paper P being irradiated with the light from the light source unit 40 will be described.

FIG. 4A is a top view of the light source unit 40 emitting light to the recording paper P. As shown in FIG. 4A, the light guide 46 of the light source unit is arranged along the conveyance direction F. Therefore, the light guide 46 emits light to the recording paper P along the conveyance direction F.

FIG. 4B is an enlarged view of a region R of the recording paper P shown in FIG. 4A and illustrates the difference in illuminance of the region R irradiated by the light source unit 40 as a gray scale. The region R corresponds to the imaging range of the imaging unit 30, for example. In FIG. 4B, parts having higher illuminance are shown brighter, and parts having lower illuminance are shown darker. As shown in FIG. 4B, along an arrow A perpendicular to the conveyance direction F, the gray scale varies in such a manner that parts closer to the light guide are shown brighter, and parts more distant from the light guide 46 are shown darker. On the other hand, along an arrow B along the conveyance direction F, the distance from the light guide 46 is constant, so that the thickness of the color is also constant, and the gray scale does not vary.

Since the gray scale does not vary along the conveyance direction F, the difference in gray scale between first image data and second image data, which are taken for the recording paper P being conveyed at different timings, can be reduced.

Since the light source unit 40 is arranged on the opposite side of the imaging unit 30 across the conveyance path, the imaging unit 30 images the recording paper P through which light is transmitted. Although the part of the light emitted by the light source unit 40 that is reflected from projections and recesses on the upper surface of the recording paper P is reflected in various directions, the part of the light that is transmitted through the recording paper P travels straight to the imaging unit 30. Therefore, the imaging unit 30 can mainly capture the light that is transmitted through the recording paper P and travels straight to the imaging unit 30, so that the influence of the projections and recesses on the surface of the recording paper P can be reduced compared with the case where the lower surface of the recording paper P is irradiated with light.

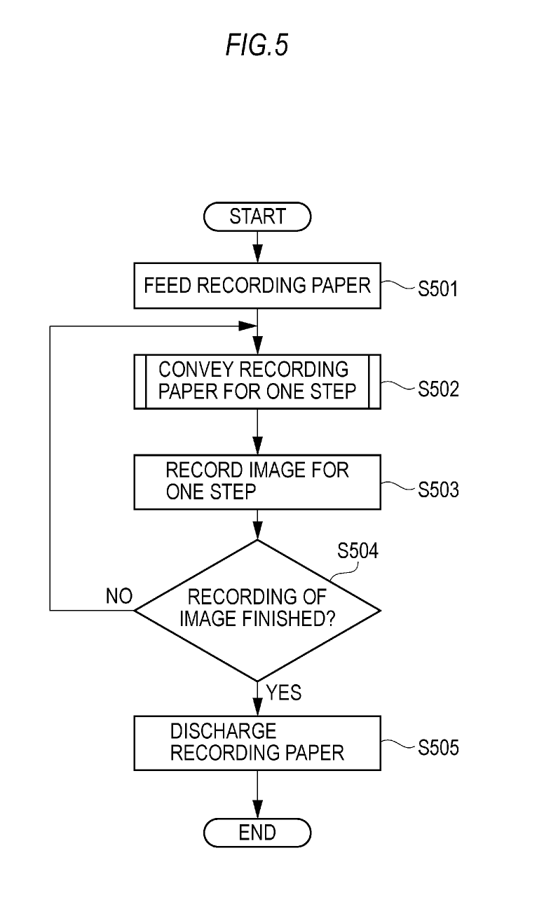

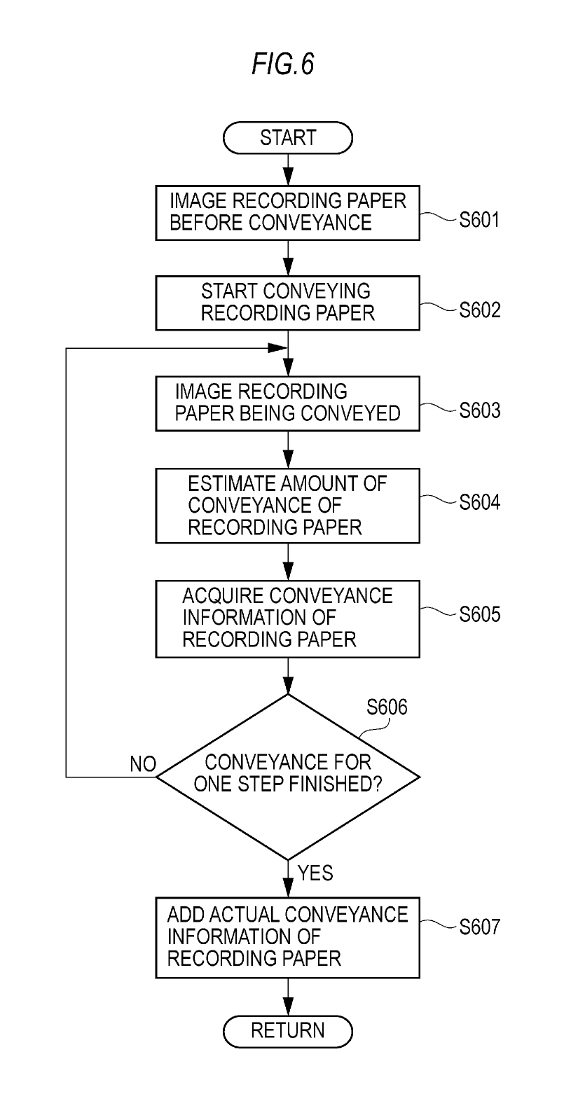

Next, a process by the control unit 60 detecting the conveyance information of the recording paper P will be described with reference to flow charts of FIGS. 5 and 6. The CPU 61 of the control unit 60 expands a program stored in the ROM 62 to the RAM 63 and executes the program to realize the flow charts of FIGS. 5 and 6.

In S501, the control unit 60 drives the paper feeding motor 25 to rotate the paper feeding roller unit 24 and separates each of the plurality of pieces of recording paper P loaded on the tray to feed the recording paper P from the paper feeding opening 14. The control unit 60 further sets a desired position for the recording paper P and drives the conveyor motor 23 to convey the recording paper P to a recording start position.

In S502, the control unit 60 drives the conveyor motor 23 to convey the recording paper P for one step. Based on the image information taken by the imaging unit 30, the control unit 60 also detects the conveyance information of the recording paper P actually conveyed at the conveyance of the recording paper P for one step, more specifically, the distance conveyed in the X direction and the distance conveyed in the Y direction. Details of the process will be described later with reference to the flow chart of FIG. 6.

In S503, the control unit 60 drives the carriage moving motor 54 to move the carriage 51 and discharges the ink from the nozzle of the recording head 52 to record the image for one step in which the recording paper P is conveyed.

In this case, the control unit 60 controls the recording head 52 to discharge the ink according to the detected actual conveyance information. Specifically, based on the actual distance conveyed in the X direction, the control unit 60 records the image throughout a region equivalent to the distance conveyed in the X direction. For example, when the distance actually conveyed is longer than the original amount of conveyance in the X direction, the image is recorded for a region including the extra length in the X direction. The control unit 60 also makes an offset equivalent to the distance conveyed in the Y direction (distance displaced in the Y direction) and records the image. Although the conveying unit 20 is not ordinarily supposed to convey the recording paper P in the Y direction, the recording paper P may be displaced in the Y direction due to slipping of the conveyor roller unit or the like. In this case, the control unit 60 records the image by shifting the timing of the start of the discharge of the ink according to the distance conveyed in the Y direction when the control unit 60 moves the recording head 52 in the Y direction.

In S504, the control unit 60 determines whether all of the recording of the image is finished. If all of the recording of the image is finished, the control unit 60 proceeds to step S505. If all of the recording of the image is not finished, the control unit 60 returns to S502 to repeat the process of S502 and S503.

In S505, the control unit 60 drives the conveyor motor 23 to discharge the recording paper P with the recorded image from the paper discharge opening 15.

Next, the process of S502 will be described with reference to the flow chart of FIG. 6.

In S601, the control unit 60 instructs the imaging unit 30 to take an image before the recording paper P is conveyed from the recording start position. The imaging unit 30 images, in the imaging range, the recording paper P through which the light is transmitted and transmits the taken image information, that is, image data, to the control unit 60. The control unit 60 applies image processing, such as shading correction, to the received image data and stores the image data after the image processing. In this case, the control unit 60 stores the image data after adding identification information to the image data. For the convenience, the stored image data will be called first image data here.

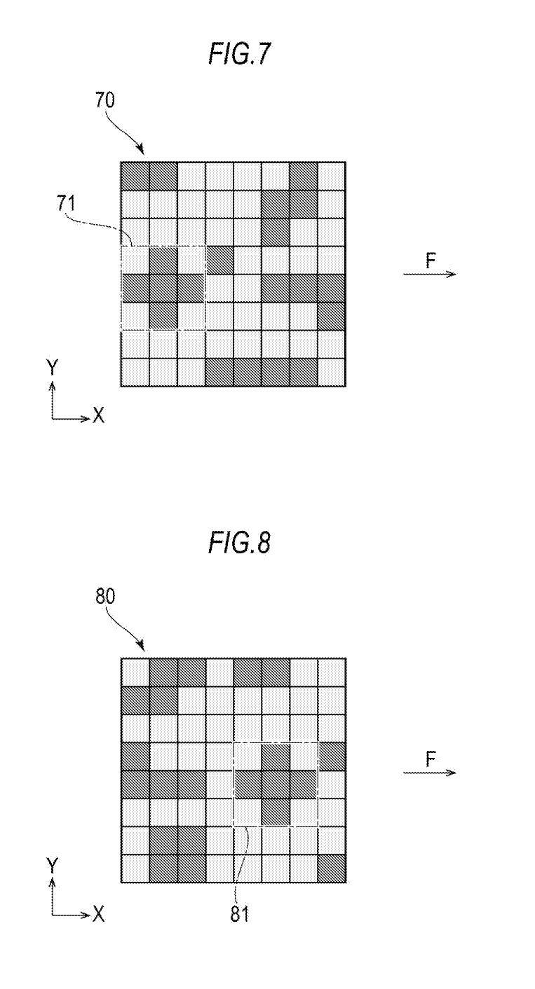

FIG. 7 is a view illustrating an example of first image data 70 imaged by the imaging unit 30. Each rectangle in the first image data 70 illustrated in FIG. 7 indicates one pixel of the image pickup element of the imaging unit 30. To facilitate the understanding, it is assumed here that the imaging range is a range of 8 pixels×8 pixels, and the image is an image with 256 black and white gradations.

As illustrated in FIG. 7, the first image data 70 indicates an image obtained by imaging the recording paper P through which the light is transmitted from below. Due to the unevenness on the upper surface and the lower surface, the recording paper P includes parts where the light is easily transmitted and parts where the light is not easily transmitted. Therefore, a pattern with different brightness values emerges in the image obtained by imaging the recording paper P. The control unit 60 extracts an image of a predetermined region (region in an alternate long and short dash line) as a template image 71 and stores brightness information and position information. For example, the control unit 60 stores the brightness value of each pixel in the template image 71 and the center coordinates of the template image 71 in the first image data 70. In FIG. 7, the center coordinates of the template image 71 are (X, Y)=(2, 4).

In S602, the control unit 60 instructs the conveyor motor 23 to start conveying the recording paper P by an amount of conveyance for one target step (hereinafter, called a target amount of conveyance). Therefore, the conveyor motor 23 rotates the first conveyor roller unit 21 to convey the recording paper P for the target amount of conveyance.

In S603, the control unit 60 instructs the imaging unit 30 to image the recording paper P being conveyed. In the same imaging range as in S601, the imaging unit 30 takes an image of the recording paper P conveyed while the light is transmitted from above, and the imaging unit 30 transmits the taken image data to the control unit 60. The control unit 60 applies image processing, such as shading correction, to the received image data and stores the image data after the image processing. In this case, the control unit 60 stores the image data after adding identification information to the image data. For the convenience, the stored image data will be called second image data here.

FIG. 8 is a view illustrating an example of second image data 80 imaged by the imaging unit 30. As illustrated in FIG. 8, in the second image data 80, a region equivalent to the template image 71 of the first image data 70 is moved in the conveyance direction F.

The timing of imaging in S603 is set in a time period (predetermined time) in which the second image data 80 includes the region equivalent to the template image 71 of the first image data 70. The predetermined time is stored in advance in the control unit 60 based on the imaging range and the conveyance speed.

In S604, the control unit 60 estimates an amount of conveyance of the recording paper P between the imaging of the last time and the imaging of this time. Specifically, the control unit 60 calculates the amount of conveyance of the recording paper P (hereinafter, called an estimated amount of conveyance) from the information detected by the encoder 26. The estimated amount of conveyance is detected based on the amount of rotation of the first conveyor roller unit 21 and is different from the actual amount of conveyance of the recording paper P when the first conveyor roller unit 21 is decentered or when there is slipping between the first conveyor roller unit 21 and the recording paper P. The control unit 60 stores the calculated estimated amount of conveyance.

In S605, the control unit 60 acquires the actual conveyance information of the recording paper P from the first image data 70 and the second image data 80.

Specifically, the control unit 60 acquires the actual conveyance information of the recording paper P by searching the position of the pattern image, which is similar to the template image 71 extracted from the first image data 70, in the second image data 80.

Here, a pattern matching method can be used as a method of searching the position of the pattern image similar to the template image 71. As illustrated in FIG. 8, the control unit 60 uses, for example, SAD (Sum of Absolute Difference) to search the pattern image similar to the template image 71 from the second image data 80 based on the brightness information of each image. In this case, the control unit 60 can quickly perform the pattern matching by searching only the proximity of the estimated amount of conveyance based on the estimated amount of conveyance calculated in S604. The control unit 60 specifies a pattern image 81 most similar to the template image 71 and acquires the position information of the specified pattern image 81. In FIG. 8, the coordinates (center coordinates) of the pattern image 81 are (X, Y)=(6, 4).

According to the present embodiment, since the light source unit 40 emits light to the recording paper P along the conveyance direction F of the recording paper P as described above, the gray scale does not vary along the conveyance direction F between the first image data 70 and the second image data 80. That is, the brightness information on the template image 71 of the first image data 70 can be prevented from changing in the second image data due to the variation in gray scale. Therefore, the control unit 60 can easily specify the pattern image 81 most similar to the template image 71.

Next, the control unit 60 calculates the actual conveyance information by obtaining the difference in the X direction and the difference in the Y direction from the coordinates of the template image 71 of the first image data 70 and the coordinates of the specified pattern image 81. In FIGS. 7 and 8, the control unit 60 can acquire the conveyance information indicating that the recording paper P is conveyed +4 pixels in the X direction and 0 pixels in the Y direction based on the difference in the coordinates. The control unit 60 stores the acquired actual conveyance information.

In S606, the control unit 60 determines whether the conveyance equivalent to one step is finished. If the conveyance equivalent to one step is not finished, the control unit 60 returns to S603 to repeat the process from S603 to S605. In this case, the control unit 60 sets, as the second image data, new image data acquired by returning to S603 and sets, as the first image data, the image data acquired in S603 of the last time to execute the process from S603 to S605. More specifically, in S603, it is preferable that the control unit 60 extracts the predetermined region as the template image 71 as in S601 and stores the brightness information and the position information, in addition to the storage of the image data after the image processing.

On the other hand, if the conveyance equivalent to one step is finished, the control unit 60 proceeds to S607. The control unit 60 proceeds to S607 when the conveyance is temporarily halted for the recording of the image by the recording unit 50 after the end of the conveyance equivalent to one step.

In S607, the control unit 60 adds all the actual conveyance information stored in S605 to acquire the conveyance information of the recording paper P actually conveyed in the conveyance for one step. Specifically, the control unit 60 adds the pixels in the X direction and the Y direction and multiplies the added pixels by the pixel pitch to acquire the distance conveyed in the X direction and the distance conveyed in the Y direction.

In this way, the control unit 60 can acquire the conveyance information of the recording paper P actually conveyed in the conveyance for one step to control the recording head 52 according to the detected actual conveyance information to discharge the ink in S503. Therefore, the control unit 60 records the image throughout the region equivalent to the distance conveyed in the X direction based on the actual distance conveyed in the X direction and records the image after offsetting the image according to the distance displaced in the Y direction. This can prevent a broken image and an overlapped image even when the recording unit 50 records the image step by step.

According to the present embodiment, the recording apparatus 100 emits light to the recording paper P imaged by the imaging unit 30 along the conveyance direction F. In this case, the gray scale on the recording paper P does not vary along the conveyance direction F. Thus, the template image can be prevented from changing due to the variation in gray scale on the image of the recording paper P between before and after the recording paper P is conveyed for a predetermined distance. Thus, highly accurate conveyance information can be detected by detecting conveyance information on the recording paper P based on the image information less affected by the variation in gray scale.

According to the present embodiment, in the recording apparatus 100, the light source unit 40 is arranged on the opposite side of the imaging unit 30 across the conveyance path. The imaging unit 30 images the recording paper P being conveyed through which the light from the light source unit 40 is transmitted. In this case, the imaging unit 30 can mainly capture the light that is transmitted through the recording paper P and travels straight to the imaging unit 30, so that the imaging can be achieved by reducing the influence of the projections and recesses on the upper and lower surfaces of the recording paper P. Since the influence of the projections and recesses is reduced, the template image obtained when the recording paper P is imaged can be prevented from changing between before and after the recording paper P is conveyed for a predetermined distance. Thus, highly accurate conveyance information can be detected by detecting conveyance information on the recording paper P based on the image information less affected by the projections and recesses.

According to the present embodiment, the light source unit 40 has the light sources 42a and 42b, and the light guide 46 that receives the light from the light sources 42a and 42b at the opposite ends in the longitudinal direction and emits the light along the conveyance direction F. Since the light guide 46 is used in the light source unit 40 in this way, a uniform amount of light can be easily emitted along the conveyance direction F.

Although a case has been described in which the first light source 42a and the second light source 42b are arranged at the opposite ends of the light guide 46 in the longitudinal direction, the present invention is not limited to this. A configuration in which any one of the light sources is arranged is also possible.

In the case described in the present embodiment, the light source unit 40 has the light sources 42a and 42b and the light guide 46. However, the present invention is not limited to this. An elongated cold cathode tube may be used as the light source unit. The cold cathode tube arranged with the longitudinal direction thereof along with the conveyance direction F can provide a continuous light emission surface along the conveyance direction F. Thus, when the cold cathode tube is used, light can be emitted to the recording paper P along the conveyance direction F as in the present embodiment.

### Second Embodiment

Next, a configuration of a light source unit 90 according to a second embodiment will be described. The light source unit 90 according to the present embodiment has the shape of a rod elongated in the conveyance direction of the recording paper P and includes a plurality of light sources that emit light arranged along the conveyance direction F of the recording paper P. Descriptions of parts common to those in the first embodiment will be appropriately omitted.

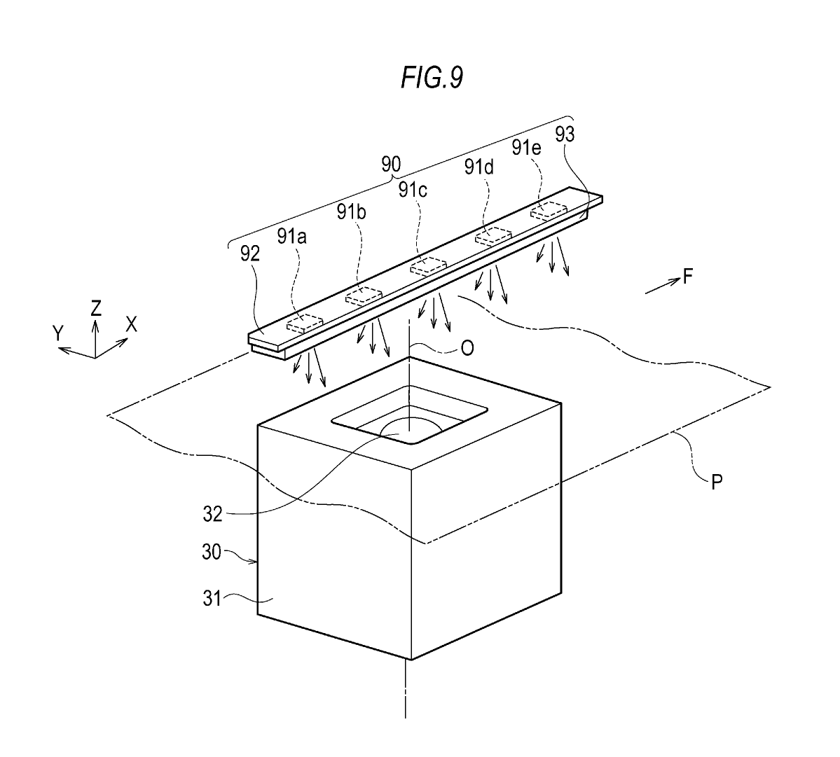

FIG. 9 is a perspective view illustrating a configuration of the light source unit 90 according to the present embodiment.

The light source unit 90 is supported by the housing 11 on the opposite side of the imaging unit 30 across the conveyance path. The light source unit has a plurality of light sources 91a to 91e, a light source substrate 92, and a diffusion member 93.

The light sources 91a to 91e are each mounted on a lower surface of the light source substrate 92 and thus arranged substantially linearly along the conveyance direction F. The light sources 91a to 91e can be LED devices similar to those of the first light source 42a and the second light source 42b described in the first embodiment. The light source unit 90 including the light sources 91a to 91e arranged along the conveyance direction F as a whole emits light to the recording paper P along the conveyance direction F. The illuminance on the recording paper P irradiated with the light from the light source unit 90 is highest at the position directly below the light source unit 90.

The light sources 91a to 91e are mounted on the light source substrate 92, and the light source substrate 92 is connected to the control unit 60 through a flexible cable of the like. The light source substrate 92 is arranged in such a manner that the light source substrate 92 intersects with the optical axis O of the lens 32 and the longitudinal direction thereof is perpendicular to the optical axis O of the lens 32.

The diffusion member 93 is attached to the light source substrate 92 to cover the light sources 91a to 91e. The diffusion member 93 mainly diffuses the light emitted from the light sources 91a to 91e in the conveyance direction F of the recording paper P. Therefore, the light source unit 90 can emits a uniform amount of light in the longitudinal direction.

According to the present embodiment, in the light source unit 90, the plurality of light sources 91a to 91e are arranged along the conveyance direction F. Since the plurality of light sources 91a to 91e are used in this way, the structure of the light source unit 90 can be simplified. Instead of being integrated with the light source unit 90, the diffusion member 93 may be arranged between the light source unit 90 and the recording paper P, that is, between the light source unit 90 and the conveyance path. The light sources 91a to 91e may be organic EL devices, for example, rather than the LED devices.

### Third Embodiment

Next, a configuration of a light source unit 110 according to a third embodiment will be described. The light source unit 110 according to the present embodiment has a configuration in which the imaging unit 30 incorporates the light source unit 40 according to the first embodiment. Thus, the light source unit 110 is arranged on the same side as the imaging unit 30 with respect to the conveyance path and emits light to the lower surface of the recording paper P. Descriptions of parts common to those in the first embodiment will be appropriately omitted.

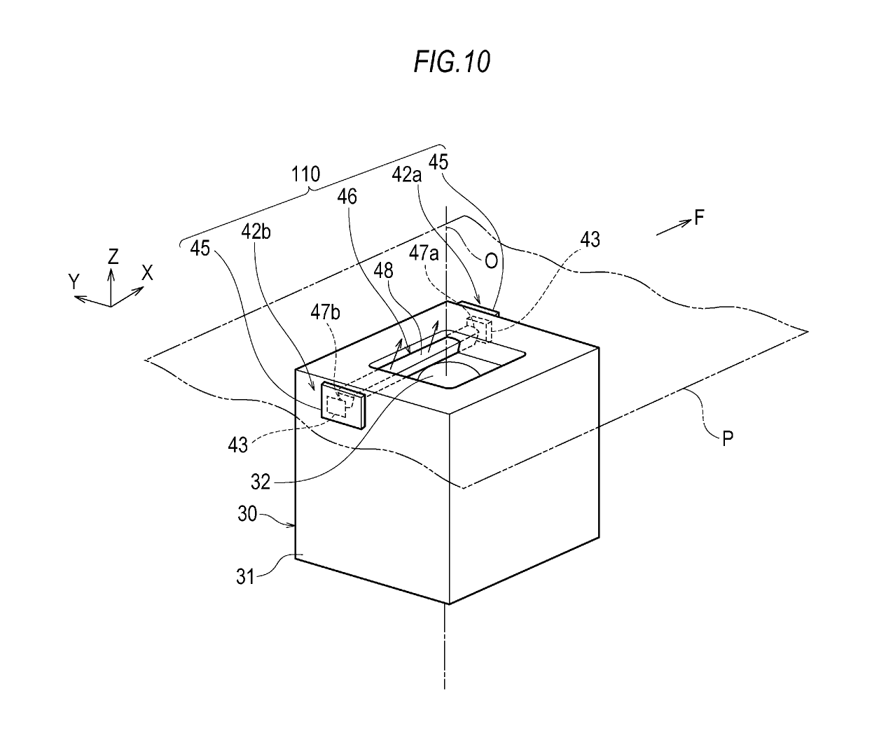

FIG. 10 is a perspective view illustrating a configuration of the light source unit 110 according to the present embodiment.

The light source unit 110 has the first light source 42a, the second light source 42b, the light source substrate 45, and the light guide 46.

The light guide 46 is incorporated in the supporting member 31 of the imaging unit 30 with the longitudinal direction thereof coincident with the conveyance direction F. The light guide 46 is arranged at a position where the light guide 46 does not intersect with the optical axis O of the lens 32 to avoid entering the imaging range of the imaging unit 30. The emission surface 48 of the light guide faces the lower surface of the recording paper P. The light guide 46 is inclined so that the illuminance on the recording paper P irradiated with the light from the emission surface 48 is highest at the position directly above the lens 32.

The first light source 42a and the second light source 42b are the same as those in the first embodiment and are positioned at the opposite ends of the light guide 46 in the longitudinal direction.

Thus, the light guide 46 emits light to the recording paper P along the conveyance direction F. When the light source unit 110 is emitting light to the recording paper P, the imaging unit 30 images the recording paper P reflecting the light.

According to the present embodiment, since the light source unit 110 is arranged on the same side as the imaging unit 30 with respect to the conveyance path, the light source unit 110 can be integrated with, or arranged close to, the imaging unit 30, so that the structure of the recording apparatus can be simplified.

In the case described in the present embodiment, the light source unit 110 has the light sources 42a and 42b and the light guide 46. However, the present invention is not limited to this, and an elongated cold cathode tube may be used as the light source unit. The cold cathode tube arranged with the longitudinal direction thereof coincident with the conveyance direction F can provide a continuous light emission surface along the conveyance direction F. Thus, when the cold cathode tube is used, light can be emitted to the recording paper P along the conveyance direction F as in the present embodiment.

### Fourth Embodiment

Next, a configuration of a light source unit 120 according to a fourth embodiment will be described. The light source unit 120 according to the present embodiment is the light source unit 90 according to the second embodiment arranged on the same side as the imaging unit 30 with respect to the conveyance path. Thus, the light source unit 120 emits light toward the lower surface of the recording paper P. Descriptions of parts common to those in the second embodiment will be appropriately omitted.

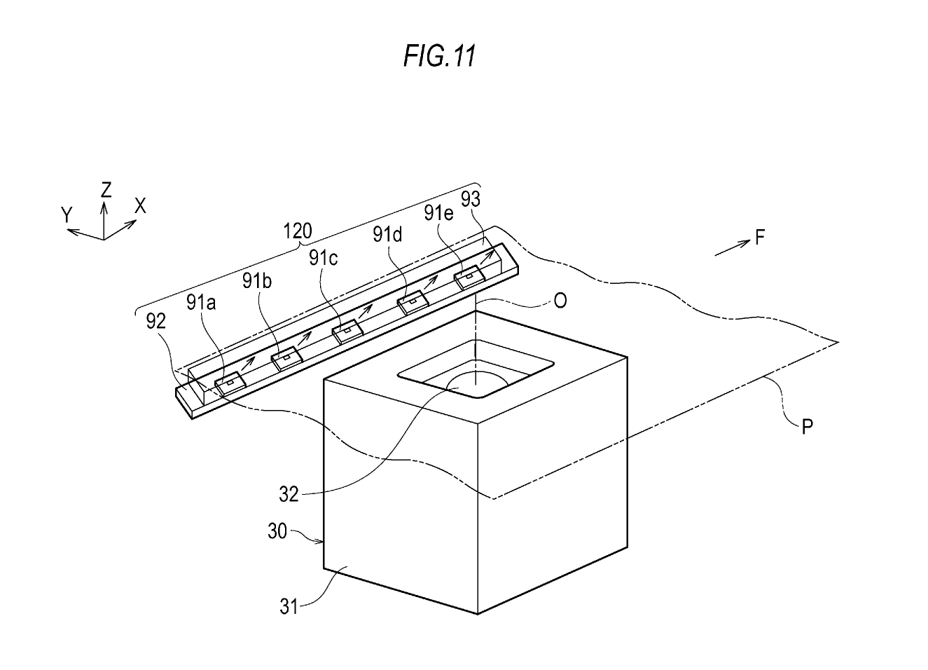

FIG. 11 is a perspective view illustrating a configuration of the light source unit 120 according to the present embodiment.

The light source unit 120 emits light toward the recording paper P imaged by the imaging unit 30 along the conveyance direction F. Here, the light source unit 120 is inclined so that the illuminance on the recording paper P irradiated with the light from the light source unit 120 is highest at the position directly above the lens 32.

As described above, the light source unit 120 emits light toward the recording paper P along the conveyance direction F.

When the light source unit 120 is emitting light to the recording paper P, the imaging unit 30 images the recording paper P reflecting the light.

According to the present embodiment, since the light source unit 120 is arranged on the same side as the imaging unit 30 with respect to the conveyance path, the light source unit 120 can be arranged close to the imaging unit 30, so that the structure of the recording apparatus 100 can be simplified. Instead of being integrated with the light source unit 120, the diffusion member 93 may be arranged between the light source unit 120 and the recording paper P, that is, between the light source unit 120 and the conveyance path. The light sources 91a to 91e may be organic EL devices, for example, rather than the LED devices.

Although embodiments of the present invention have been described above, the present invention is not limited only to the embodiments described above. Various modifications are possible, and some of the embodiments can be combined, without departing from the scope of the present invention.

Although the recording apparatus 100 has been described in the above embodiments as an example, the present invention is not limited to this and can be applied to the conveying apparatus 10 without the recording unit 50. Note that examples of the conveying apparatus 10 include an image reading apparatus, such as a scanner, in which the configuration of the recording unit 50 is replaced with a configuration of an image reading unit.

In the cases described in the embodiments, the imaging unit 30 is arranged below the conveyance path. However, the present invention is not limited to this, and the imaging unit 30 may be arranged above the conveyance path. When the imaging unit 30 is arranged above the conveyance path, the light source unit 40 according to the first embodiment and the light source unit 90 according to the second embodiment can be arranged below the imaging unit 30 across the conveyance path. When the imaging unit 30 is arranged above the conveyance path, the light source unit 110 according to the third embodiment and the light source unit 120 according to the fourth embodiment can be arranged above the conveyance path, that is, on the same side as the imaging unit 30.

Although the control unit 60 is arranged in the housing 11 in the cases described in the embodiments, the present invention is not limited to the case, and the control unit 60 may be arranged outside of the housing 11. In this case, the control unit 60 can control the conveying apparatus 10 and the recording unit 50 in a wired or wireless manner.

In the cases described in the embodiments, SAD is used as a pattern matching process. However, the present invention is not limited to SAD, and SSD (Sum of Squared Difference), NCC (Normalized Cross-Correlation) or the like can also be used.

Although the CPU 61 executes the program to realize the process in the cases described in the embodiments, the present invention is not limited to the case, and each circuit including hardware may execute the process.

The present invention also includes the program and a computer-readable recording medium recording the program.

According to the present invention, highly accurate conveyance information can be detected.

It should be noted that the above embodiments merely illustrate concrete examples of implementing the present invention, and the technical scope of the present invention is not to be construed in a restrictive manner by these embodiments. That is, the present invention may be implemented in various forms without departing from the technical spirit or main features thereof.

What is claimed is:

1. A conveying apparatus, comprising:
a conveying unit that conveys a conveyed object along a conveyance path;
an imaging unit that images the conveyed object to detect conveyance information on the conveyed object; and
a light source unit that emits light to the conveyed object imaged by the imaging unit,
wherein the light source unit has a shape of a rod elongated in a conveyance direction of the conveyed object.

2. The conveying apparatus according to claim 1, wherein
the light source unit emits light to the conveyed object along the conveyance direction of the conveyed object.

3. The conveying apparatus according to claim 1, wherein
the light emitted to the conveyed object by the light source unit does not vary in gray scale in the conveyance direction.

4. The conveying apparatus according to claim 1, wherein
the light source unit has an emission surface from which the light is emitted, and
the emission surface is continuous in the conveyance direction of the conveyed object.

5. The conveying apparatus according to claim 1, wherein
the light source unit has:
a light source; and
a light guide that receives light from the light source at an end in a longitudinal direction and emits the light along the conveyance direction of the conveyed object.

6. The conveying apparatus according to claim 1, wherein
the light source unit is a cold cathode tube arranged in the conveyance direction of the conveyed object.

7. The conveying apparatus according to claim 1, wherein
the light source unit includes a plurality of light sources that emit light, the plurality of light sources being arranged in the conveyance direction of the conveyed object.

8. The conveying apparatus according to claim 7, wherein
the conveying apparatus has a diffusion member between the light source unit and the conveyance path.

9. The conveying apparatus according to claim 1, wherein
the light source unit is arranged on an opposite side of the imaging unit across the conveyance path, and
the imaging unit images the conveyed object through which the light emitted from the light source unit is transmitted.

10. The conveying apparatus according to claim 1, wherein
the light source unit is arranged on a same side as the imaging unit with respect to the conveyance path, and
the imaging unit images the conveyed object reflecting the light emitted from the light source unit.

11. A recording apparatus, comprising:
a conveying unit that conveys a conveyed object along a conveyance path;
an imaging unit that images the conveyed object to detect conveyance information on the conveyed object;
a light source unit that emits light to the conveyed object imaged by the imaging unit; and
a recording unit that records an image on the conveyed object conveyed by the conveying unit,
wherein the light source unit has a shape of a rod elongated in a conveyance direction of the conveyed object.
